(19) United States
(12) Patent Application Publication
(10) Pub. No.: US 2024/0378429 A1
(43) Pub. Date: Nov. 14, 2024

(54) SPIKING NEURAL NETWORK CIRCUIT INCLUDING DOUBLE PRECISION ASYNCHRONOUS NEURONS AND METHOD OF OPERATION THEREOF

(71) Applicant: ELECTRONICS AND TELECOMMUNICATIONS RESEARCH INSTITUTE, Daejeon (KR)

(72) Inventors: Kwang IL OH, Daejeon (KR); Tae Wook KANG, Daejeon (KR); Hyuk KIM, Daejeon (KR); Jae-Jin LEE, Daejeon (KR)

(21) Appl. No.: 18/406,349

(22) Filed: Jan. 8, 2024

(30) Foreign Application Priority Data
May 8, 2023 (KR) 10-2023-0059116

(51) Int. Cl. G06N 3/049

(52) U.S. Cl. CPC G06N 3/049

(57) ABSTRACT

Disclosed is a spiking neural network circuit, which includes an axon circuit that generates an input spike signal, a synapse circuit that outputs a current based on the input spike signal and a weight, a capacitor that forms a membrane voltage based on the current, and a neuron circuit that generates an output spike signal based on the membrane voltage, and the neuron circuit includes a first comparator that generates an intermediate spike signal based on the membrane voltage and a first reference voltage, and a second comparator that generates the output spike signal based on the intermediate spike signal, the membrane voltage, and a second reference voltage that is different from the first reference voltage.

### CROSS-REFERENCE TO RELATED APPLICATION(S)

This application claims priority under 35 U.S.C. § 119 to Korean Patent Application No. 10-2023-0059116 filed on May 8, 2023, in the Korean Intellectual Property Office, the disclosures of which are incorporated by reference herein in their entireties.

### BACKGROUND

### 1. Field of the Invention

Embodiments of the present disclosure described herein relate to a spike neural network circuit, and more particularly, relate to a spike neural network circuit including double precision asynchronous neurons and a method of operating the same.

### 2. Description of Related Art

A spiking neural network (SNN) circuit is one of the methods of implementing an artificial intelligence network that performs network operations on inputs and transmits outputs. Spiking neural networks may be implemented with the spiking neural network circuit using a semiconductor device. Spiking neural network circuits transfer inputs and signals in the form of pulses or spikes with a short time width.

The spiking neural network circuits perform operations in a synapse circuit so as to be transferred to the neuron circuit. In this case, a voltage or charge provided from a synapse circuit is accumulated in a membrane capacitor of the neuron circuit, and when it exceeds a threshold voltage, a neuron fires. Therefore, the precision of a comparator that performs the operation of comparing the charge accumulated in the membrane capacitor with a threshold voltage becomes an important factor in determining outputs. However, high-precision comparators are large in size and use high threshold voltages, so the comparators have limitations in terms of power consumption.

### SUMMARY

Embodiments of the present disclosure provide a spike neural network circuit including double precision asynchronous neurons and a method of operating the same.

According to an embodiment of the present disclosure, a spiking neural network circuit includes an axon circuit that generates an input spike signal, a synapse circuit that outputs a current based on the input spike signal and a weight, a capacitor that forms a membrane voltage based on the current, and a neuron circuit that generates an output spike signal based on the membrane voltage, and the neuron circuit includes a first comparator that generates an intermediate spike signal based on the membrane voltage and a first reference voltage, and a second comparator that generates the output spike signal based on the intermediate spike signal, the membrane voltage, and a second reference voltage that is different from the first reference voltage.

According to an embodiment, the first reference voltage may be lower than the second reference voltage.

According to an embodiment, the first comparator may include a first input transistor having a first width and a first length, the second comparator may include a second input transistor having a second width and a second length, the second width may be ‘n’ times the first width, and the second length may be ‘n’ times the first length, and where ‘n’ may be any natural number.

According to an embodiment, the spiking neural network circuit may further include a latch circuit that generates a high-precision comparator enable signal based on the intermediate spike signal, and the second comparator may operate only when a logic value of the high-precision comparator enable signal is ‘1’.

According to an embodiment, when the membrane voltage is greater than the first reference voltage, the first comparator may output a logic value of the intermediate spike signal as ‘1’, the latch circuit may output the logic value of the high-precision comparator enable signal as ‘1’ based on the logic value of the intermediate spike signal being ‘1’, and the second comparator may compare the membrane voltage with the second reference voltage based on the logic value of the high-precision comparator enable signal being ‘1’.

According to an embodiment, the input spike signal may be a first input spike signal, the axon circuit may be a first axon circuit, and the spiking neural network circuit may further include a second axon circuit that generates a second input spike signal, and an address encoder that receives an input address signal indicating one of the first axon circuit and the second axon circuit and a raw input signal, and transfers the raw input signal to one of the first axon circuit and the second axon circuit in response to the input address signal.

According to an embodiment, the address encoder may generate a comparator enable signal based on the raw input signal, and the first comparator and the second comparator may not operate when a logic value of the comparator enable signal is ‘0’.

According to an embodiment, the membrane voltage may be a first membrane voltage, the capacitor may be a first capacitor, the output spike signal may be a first output spike signal, the neuron circuit may be a first neuron circuit, and the spiking neural network circuit may further include a second capacitor that forms a second membrane voltage, a second neuron circuit that generates a second output spike signal based on the second membrane voltage, and a WTA device that decreases the first membrane voltage and the second membrane voltage to a potential level of a ground power supply when one of the first output spike signal and the second output spike signal is received.

According to an embodiment, the spiking neural network circuit may further include an address encoder, and the address encoder may output an output address signal indicating the first neuron circuit when the WTA device receives the first output spike signal, and may output an output address signal indicating the second neuron circuit when the WTA device circuit receives the second output spike signal.

According to an embodiment of the present disclosure, a method of operating a spiking neural network circuit including a first comparator and a second comparator includes generating an input spike signal, outputting a current based on the input spike signal and a weight, forming a membrane voltage based on the current, generating, by the first comparator, an intermediate spike signal based on the membrane voltage and a first reference voltage, and generating, by the second comparator, an output spike signal based on the intermediate spike signal, the membrane voltage, and a second reference voltage that is different from the first reference voltage.

According to an embodiment, the first reference voltage may be lower than the second reference voltage.

According to an embodiment, the generating, by the second comparator, of the output spike signal based on the intermediate spike signal, the membrane voltage, and the second reference voltage that is different from the first reference voltage may include generating a high-precision comparator enable signal based on the intermediate spike signal, and when the logic value of the high-precision comparator enable signal is ‘1’, comparing, by the second comparator, the membrane voltage with the second reference voltage to generate the output spike signal.

According to an embodiment, the generating, by the first comparator, of the intermediate spike signal based on the membrane voltage and the first reference voltage may include outputting, by the first comparator, a logic value of the intermediate spike signal as ‘1’ when the membrane voltage is greater than the first reference voltage, and the generating of the high-precision comparator enable signal based on the intermediate spike signal may include, when the logic value of the intermediate spike signal is ‘1’, outputting the logic value of the high-precision comparator enable signal as ‘1’.

### BRIEF DESCRIPTION OF THE DRAWINGS

The above and other objects and features of the present disclosure will become apparent by describing in detail embodiments thereof with reference to the accompanying drawings.

FIG. 1 is a diagram illustrating a spiking neural network circuit according to a conventional art.

FIG. 2 is a diagram illustrating a spiking neural network circuit according to a conventional art.

FIG. 3 is a diagram illustrating a neuron circuit of FIGS. 1 and 2 according to a conventional art.

FIG. 4 is a timing diagram describing operations of a synapse circuit and a neuron circuit with respect to an input spike signal in a spiking neural network circuit of FIG. 1, according to a conventional art.

FIG. 5 is a diagram illustrating a spiking neural network circuit according to some embodiments of the present disclosure.

FIG. 6 is a diagram illustrating a double precision neuron circuit of FIG. 5, according to some embodiments of the present disclosure.

FIG. 7 is a diagram illustrating an address decoder of FIG. 5, according to some embodiments of the present disclosure.

FIG. 8 is a diagram illustrating a circuit implementing a WTA device of FIG. 5, according to some embodiments of the present disclosure.

FIG. 9 is a timing diagram describing operations of an axon circuit, a synapse circuit, and a neuron circuit with respect to a raw input signal in a spiking neural network circuit of FIG. 5, according to some embodiments of the present disclosure.

FIG. 10 is a diagram illustrating a first comparator and a second comparator of FIG. 6, according to some embodiments of the present disclosure.

FIG. 11 is a flowchart describing a method of operating a spiking neural network circuit, according to some embodiments of the present disclosure.

### DETAILED DESCRIPTION

Hereinafter, embodiments of the present disclosure will be described in detail and clearly to such an extent that an ordinary one in the art easily implements the present disclosure.

Hereinafter, several embodiments of the present disclosure will be described in more detail with reference to accompanying drawings. Hereinafter, in order to facilitate overall understanding in describing the present disclosure, similar reference numerals are used for similar components in the drawings, and in order to clearly descript the technical idea of the present disclosure, detailed descriptions of overlapping components will be omitted to avoid redundancy.

The present disclosure relates to a circuit implemented in a semiconductor device to perform neural network operations. The neural network of the present disclosure may be an artificial neural network (ANN) that may process data or information in a manner similar to a biological neural network. The neural network may include multiple layers containing artificial neurons similar to biological neurons and synapses connecting the multiple layers. Hereinafter, a spiking neural network that processes a spike signal having a pulse shape that toggles for a short period of time will be representatively described. However, the circuit according to an embodiment of the present disclosure is not limited to the spiking neural network and may also be used to implement other neural networks.

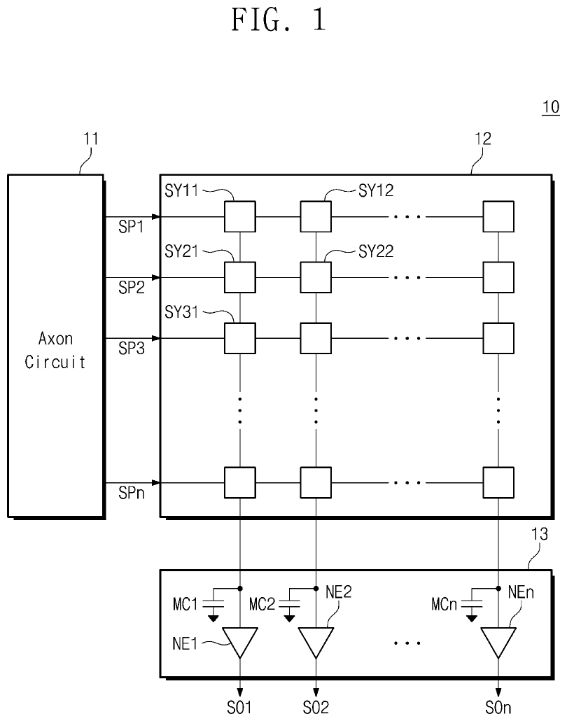

FIG. 1 is a diagram illustrating a spiking neural network circuit according to a conventional art. Referring to FIG. 1, a spiking neural network circuit 10 according to a conventional art is illustrated.

An axon circuit 11 may include axons that generate input spike signals. The axon of the axon circuit 11 may perform the function of outputting signals to other neurons, similar to the axon of a biological neural network. For example, each of the axons of the axon circuit 11 may generate an input spike signal based on data input from the outside to the spiking neural network circuit 10. As another example, each of the axons of the axon circuit 11 may first receive (feedback) output spike signals output from a neuron array 13 according to the input spike signals transmitted to a synapse array 12 and may generate a new input spike signal based on the output spike signals. The input spike signal may be a pulse signal that toggles for a short period of time. The axon circuit 11 may generate input spike signals SP1 to SPn so as to be transmitted to the synapse array 12.

The synapse array 12 may connect the axon circuit 11 to the neuron array 13. The synapse array 12 may include a plurality of synapse circuits (e.g., SY11, SY21, SY31, S12, and S22) that determine whether there is a connection and a strength of the connection between the axons of the axon circuit 11 and neuron circuits NE1 to NEn of the neuron array 13. Each of the synapse circuits may have a corresponding weight. Each of the synapse circuits may receive an input spike signal, and a weight may be applied to the received input spike signal. For example, the synapse circuits may perform operations to apply respective weights to the received input spike signal. The weight may be a numerical value representing a correlation between the axons described above and neuron circuits, a connection strength between the axons of the axon circuit 11 and the neuron circuits of the neuron array 13, and a correlation of (subsequent) neuron circuits of the neuron array 13 with respect to the input spiking signal. For example, the synapse array 12 may output a result to which the weight is applied with respect to the input spike signals to the neuron array 13. The result to which the weight is applied with respect to the input spike signals may be a current or a charge.

Referring to FIG. 1, the synapse array 12 is illustrated as a two-dimensional array, and the synapse circuits are illustrated as being arranged on the two-dimensional array. For example, the input spike signals may be transmitted in a first direction from the axon circuit 11 to the synapse array 12. The result to which the weight is applied with respect to the input spike signals may be transmitted in a second direction from the synapse array 12 to the neuron array 13. For example, the first direction and the second direction may be perpendicular to each other. However, unlike the illustration in FIG. 1, the synapse circuits may be arranged on a three-dimensional array.

The neuron array 13 may include membrane capacitors MC1 to MCn and neuron circuits NE1 to NEn.

Each of the membrane capacitors MC1 to MCn may be connected between a node connected to the synapse array 12 and a ground power supply. Each of the membrane capacitors MC1 to MCn may accumulate the result to which the weight is applied with respect to the input spike signals received from the synapse array 12. For example, the membrane capacitor may receive a current from the synapse array 12 to form a membrane voltage.

For brief description, the present disclosure is mainly described in a case where a voltage of the membrane capacitor increases as the result to which the weight is applied with respect to the input spike signals is accumulated. However, the scope of the present disclosure is not limited thereto, and the present disclosure includes a case where a voltage of the membrane capacitor decreases as operation signals are accumulated.

Each of the neuron circuits NE1 to NEn may have a threshold voltage. The threshold voltage may also be referred to as a reference voltage and may be a preset voltage level. Each of the neuron circuits NE1 to NEn may generate an output spike signal based on the corresponding membrane voltage and threshold voltage.

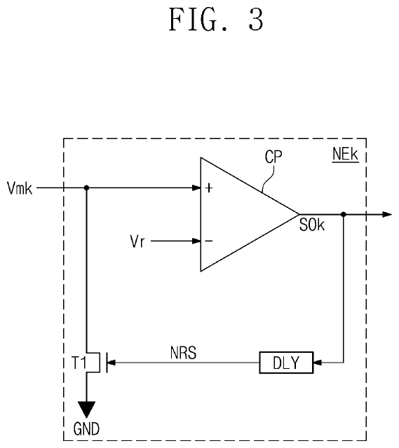

For example, the first neuron circuit NE1 may output a first output spike signal SO1 when the membrane voltage formed in the first membrane capacitor MC1 is greater than a reference voltage. The membrane voltage formed in the first membrane capacitor MC1 is greater than the reference voltage, so the first neuron circuit NE1 outputs the first output spike signal SO1, which means that the first neuron circuit NE1 fires. A more detailed description of the neuron circuit will be described later with reference to FIG. 3.

The output spike signals SO1 to SOn output from the neuron array 13 may be provided back to the axon circuit 11, may be output to the outside of the spiking neural network circuit 10, or may be output to other components of the spiking neural network circuit 10.

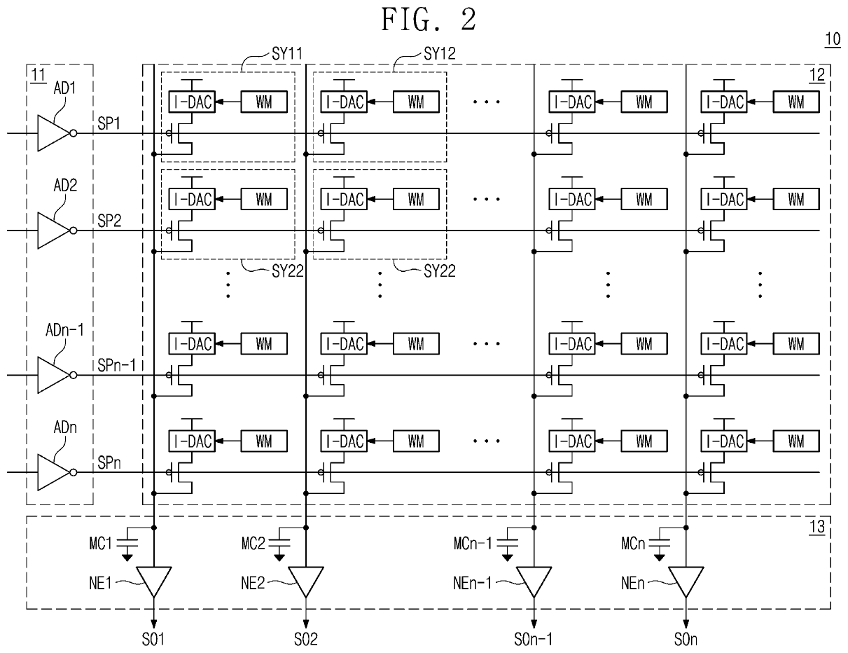

FIG. 2 is a diagram illustrating a spiking neural network circuit according to a conventional art. Referring to FIG. 2, an example circuit diagram of the axon circuit 11 and the synapse array 12 of FIG. 1 is illustrated. Since the neuron array 13 in FIG. 2 is the same as the neuron array 13 in FIG. 1, description thereof will be omitted.

The axon circuit 11 may include axon drivers AD1 to ADn. For example, each of the axon drivers AD1 to ADn may be implemented with an inverter. Each of the axon drivers AD1 to ADn may receive an input signal and may transmit the received input signal to the synapse array 12 as the input spike signals SP1 to SPn.

The synapse circuits (e.g., SY11, SY21, SY12, and SY22) of the synapse array 12 may include a transistor, a weight memory WM, and a Current-mode Digital-to-Analog Converter (I-DAC), respectively.

The weight memory WM may store predefined weights. The weight memory WM may provide stored weights to the I-DAC. For example, the weight memory WM may be implemented as a binary memory. The weight memory WM may be implemented as a memory that may store 8 bits. However, the scope of the present disclosure is not limited thereto, and the size of the binary memory may be implemented in various ways depending on the purpose of the spiking neural network circuit.

The I-DAC may receive weights from the weight memory WM. The I-DAC may convert the weights into signals that may be applied to the input spike signal.

For a concise description, a transistor of the synapse circuit will be mainly described as an embodiment implemented as a PMOS transistor (p-channel metal-oxide-semiconductor field-effect transistor). A gate terminal of a transistor of the synapse circuit may receive the input spike signal from the axon circuit 11, a source terminal of the transistor may be connected to the I-DAC, and a drain terminal of the transistor may be connected to the same node as a membrane capacitor.

FIG. 3 is a diagram illustrating a neuron circuit of FIGS. 1 and 2 according to a conventional art. Referring to FIG. 3, a circuit diagram of one neuron circuit NEK among the neuron circuits NE1 to NEn of FIGS. 1 and 2 is illustrated.

The neuron circuit NEK may include a comparator CP, a delay circuit DLY, and a first transistor T1.

The comparator CP may receive a membrane voltage Vmk as a positive (+) input. The membrane voltage Vmk may refer to the voltage formed by the membrane capacitor corresponding to the neuron circuit NEK. The comparator CP may receive a reference voltage Vr as a negative (−) input. The voltage level of the reference voltage Vr may be determined in advance.

The comparator CP may output an output spike signal SOk right when the membrane voltage Vmk becomes greater than the reference voltage Vr. In detail, right when the membrane voltage Vmk becomes greater than the reference voltage Vr, the neuron circuit NEK may fire.

In contrast, the comparator CP does not output the output spike signal SOk when the membrane voltage Vmk is lower than the reference voltage Vr. In detail, the neuron circuit NEK does not fire.

The operation in which the comparator CP compares the membrane voltage Vm with the reference voltage Vr may be referred to as a comparison operation.

The delay circuit DLY may receive the output spike signal SOk and may output a neuron reset signal NRS. There may be a specific time difference between the time when the output spike signal SOk is output and the time when the neuron reset signal NRS is output. The delay circuit DLY may transfer the neuron reset signal NRS to the gate terminal of a first transistor T1.

The first transistor T1 may be implemented as an NMOS transistor (n-channel metal-oxide-semiconductor field-effect transistor). The gate terminal of the first transistor T1 may receive the neuron reset signal NRS from the delay circuit DLY, and upon receiving the neuron reset signal NRS, the first transistor T1 may be turned on. The source terminal of the first transistor T1 may be connected to a ground terminal GND, and the drain terminal thereof may be connected to the same node as the positive (+) terminal of the comparator CP to which the membrane voltage is applied.

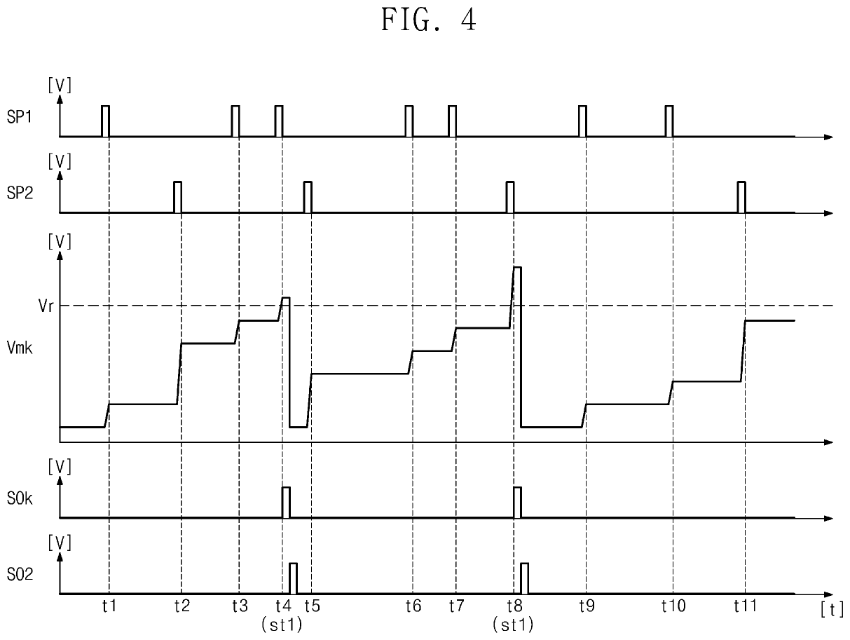

FIG. 4 is a timing diagram describing operations of a synapse circuit and a neuron circuit with respect to an input spike signal in a spiking neural network circuit of FIG. 1, according to a conventional art. In FIG. 4, a horizontal axis may represent a time “t”, and a vertical axis may represent a voltage “v”. Components having the same reference numerals as the components of FIGS. 1 and 3, which are described with reference to the drawings below, may mean components that are the same as or similar to the components of FIGS. 1 and 3.

When the first input spike signal SP1 and the second input spike signal SP2 are received from each of the two different axons of the axon circuit 11, the membrane voltage Vmk may increase based on the weight determined in the synapse circuit.

In some embodiments, weights corresponding to each of two different axons may be the same or different. For concise and detailed description, it is assumed that the weight corresponding to the second input spike signal SP2 is greater than the weight corresponding to the first input spike signal SP1, but the scope of the present disclosure is not limited thereto.

Continuing to refer to FIG. 4, when the input spike signal is input at a first time to a fourth time t1 to t4 and a fifth time to an eighth time t5 to t8, the membrane voltage Vmk increases (or the membrane capacitor is charged). Among these, at the second time t2, the fifth time t5, and the eighth time t8, the weight corresponding to the second input spike signal SP2 is operated, so the increase amount (e.g., the increase amount in membrane voltage Vmk at t2, t5, and t8) in membrane voltage Vmk by the second input spike signal SP2 may be greater than the increase amount (e.g., the increase amount in membrane voltage Vmk at t1, t3, t4, t6, and t7) in membrane voltage Vmk by the first input spike signal SP1.

At the fourth time t4 and the eighth time t8 when the membrane voltage Vmk exceeds the reference voltage Vr, the neuron circuit may fire and output the output spike signal SOk. In detail, the frequency and timing of the output spike signal output through the firing of the neuron circuit may vary depending on the firing period of the input spike signal and the size of the weight stored in the synapse circuit.

After a specific delay time after the output spike signal SOk is output, the neuron circuit may output the neuron reset signal NRS to the transistor connected to the ground terminal GND. When the first transistor T1 connected to the ground terminal GND is turned on by the neuron reset signal NRS, the potential of the membrane voltage Vmk may decrease to a potential level of the ground terminal GND.

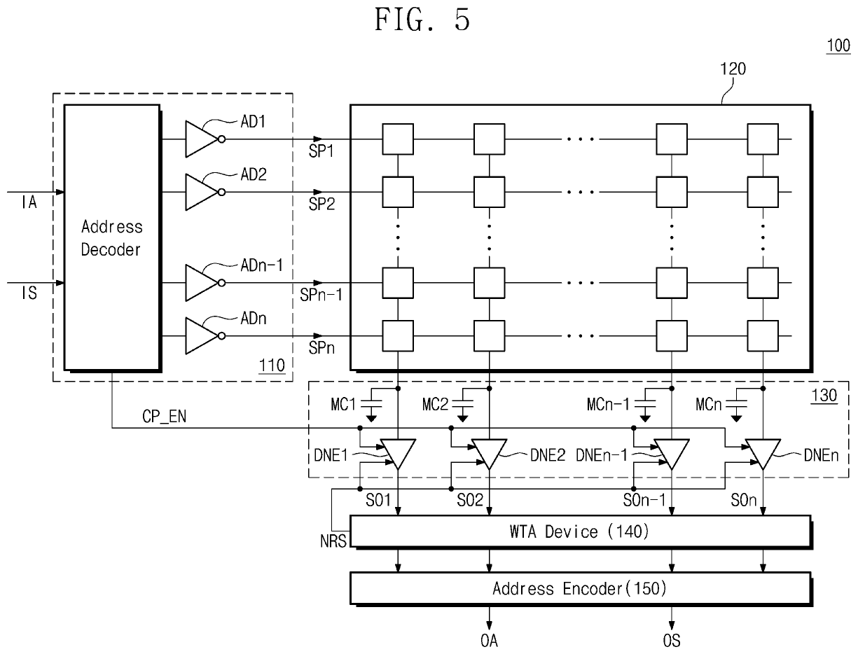

FIG. 5 is a diagram illustrating a spiking neural network circuit according to some embodiments of the present disclosure. Referring to FIG. 5, a spiking neural network circuit 100 according to the present disclosure is illustrated. Since the operation of a synapse array 120 in FIG. 5 is similar to the operation of the synapse array 12 in FIG. 1, additional description will be omitted to avoid redundancy. In the description of an axon circuit 110 and a neuron array 130 of FIG. 5, parts similar to the operations of the axon circuit 11 and the neuron array 13 of FIG. 1 may be omitted below to avoid redundancy.

The spiking neural network circuit 100 may include the axon circuit 110, the synapse array 120, the neuron array 130, a winner-takes-all (WTA) device 140, and an address encoder 150.

The axon circuit 110 may receive an input address signal IA and a raw input signal IS and may output the input spike signals SP1 to SPn to the synapse array 120 through the axons.

The input address signal IA may be ‘n’ bits indicating one of the axons. The ‘n’ may be any natural number. In this case, the maximum number of axons that may be indicated by the input address signal IA may be 2″.

The raw input signal IS may indicate the spike signal corresponding to data input to the spiking neural network circuit 100 from the outside.

When the raw input signal IS is input to the axon circuit 110, the axon pointed to by the input address signal IA at the point when the raw input signal IS is input may generate an input spike signal corresponding to the raw input signal IS.

For example, when the input address signal IA points to a first axon at the point when the raw input signal IS is input, the spike signal corresponding to the raw input signal IS may be output to the synapse array 120 as the input spike signal SP1 through the first axon.

The axon circuit 110 may include the address decoder and the axon drivers AD1 to ADn.

The address decoder may receive the input address signal IA and the raw input signal IS. The address decoder may output the spike signal corresponding to the raw input signal IS to the axon pointed to by the input address signal IA.

The address decoder may include a delay circuit. When the address decoder outputs a spike signal corresponding to the raw input signal IS, the address decoder may output a comparator enable signal CP_EN to each of double precision neuron circuits DNE1 to DNEn of the neuron array 130 after a specific delay time through the delay circuit. The comparator enable signal CP_EN may enable an operation of the comparator included in the neuron circuit. In detail, the comparator may perform a comparison operation only when the comparator enable signal CP_EN is received.

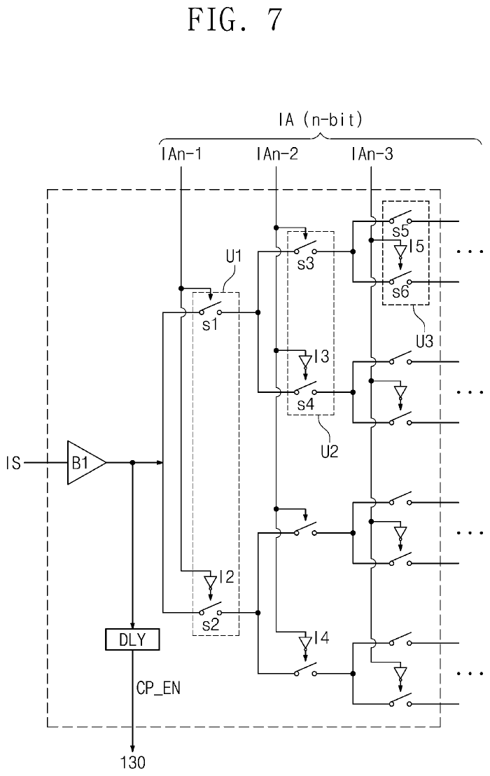

A more detailed description of the address decoder will be described later with reference to FIG. 7.

When a spike signal from the address decoder is received, each of the axon drivers AD1 to ADn may invert the spike signal and may output the inverted spike signal to the synapse array 120 as the input spike signal. For example, each of the axon drivers AD1 to ADn may be implemented with an inverter.

The neuron array 130 may include the double precision neuron circuits DNE1 to DNEn and the membrane capacitors MC1 to MCn.

Each of the double precision neuron circuits DNE1 to DNEn may include two comparators of different precision. For example, each of the double precision neuron circuits DNE1 to DNEn may include a first comparator and a second comparator.

A reference voltage of the first comparator may be lower than a reference voltage of the second comparator. In some embodiments, the first comparator may be implemented in a smaller size and may consume less power than the second comparator.

The reference voltage of the second comparator may be greater than the reference voltage of the first comparator. In some embodiments, the second comparator may be implemented in a larger size than the first comparator and may consume more power.

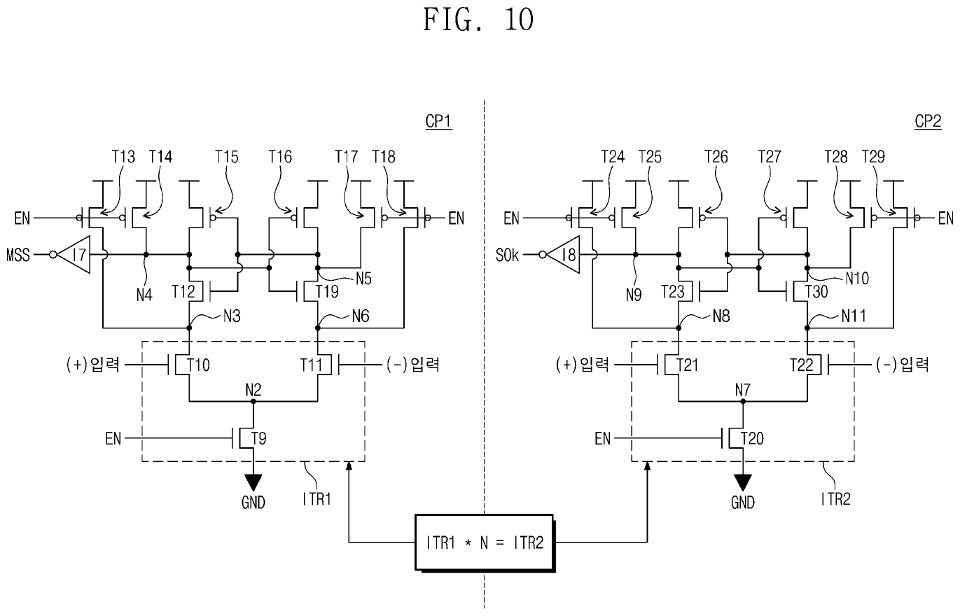

A more detailed description of the first comparator and the second comparator will be described later with reference to FIG. 10.

The double precision neuron circuits DNE1 to DNEn may receive the comparator enable signal CP_EN from the address encoder. The comparators included in the double precision neuron circuits DNE1 to DNEn may perform comparison operations only when receiving the comparator enable signal CP_EN.

The double precision neuron circuits DNE1 to DNEn may receive the neuron reset signal RNS from the WTA device 140. When each of the double precision neuron circuits DNE1 to DNEn receives the neuron reset signal NRS, the corresponding membrane voltage may decrease to the potential level of the ground terminal GND.

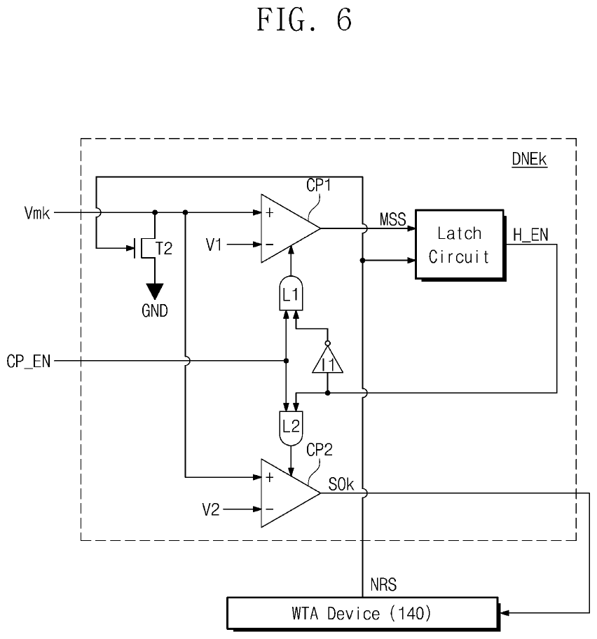

When each of the double precision neuron circuits DNE1 to DNEn receives the comparator enable signal CP_EN and does not receive the neuron reset signal NRS, the each of the double precision neuron circuits DNE1 to DNEn may output each of the output spike signals SO1 to SON when the membrane voltage is greater than the reference voltage of the second comparator. A more detailed description of the double precision neuron circuits DNE1 to DNEn will be described later with reference to FIG. 6.

The WTA device 140 may receive the output spike signals SO1 to SOn from the neuron array 130. The WTA device 140 may output the neuron reset signal NRS to the neuron array 130 when the output spike signal from one of the double precision neuron circuits DNE1 to DNEn included in the neuron array 130 is received.

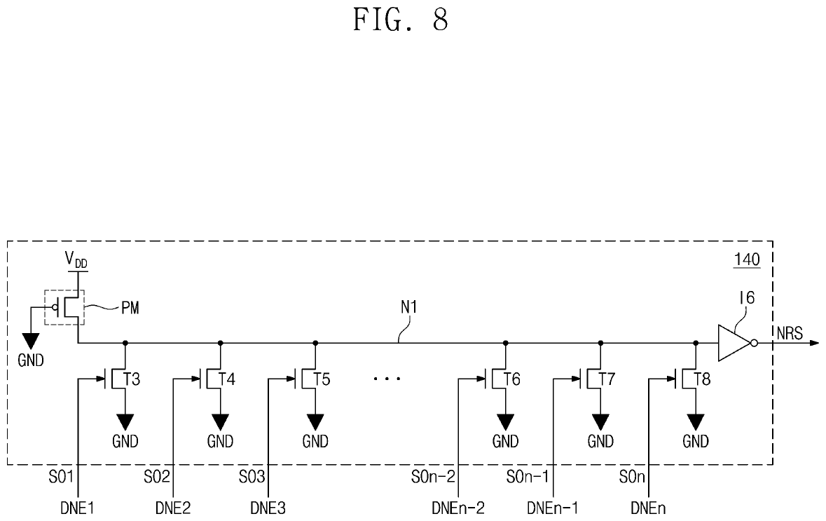

In detail, when the output spike signal of the first firing double precision neuron circuit among the double precision neuron circuits DNE1 to DNEn is received, the membrane voltage of all double precision neuron circuits including the fired double precision neuron circuit may decrease to the potential level of the ground terminal GND. A more detailed description of the WTA device 140 will be described later with reference to FIG. 8.

The address encoder 150 may receive the output spike signals SO1 to SOn from the WTA device 140. The address encoder 150 may encode the output spike signal into an output address signal OA and a raw output signal OS so as to be output.

The output address signal OA may indicate one double precision neuron circuit from which the output spike signal is output among the double precision neuron circuits DNE1 to DNEn.

The raw output signal OS may be a spike signal corresponding to the output spike signal.

FIG. 6 is a diagram illustrating a double precision neuron circuit of FIG. 5, according to some embodiments of the present disclosure. Referring to FIG. 6, a circuit diagram of a double precision neuron circuit DNEK of FIG. 5 is illustrated. The double precision neuron circuit DNEK of FIG. 6 may be one of the double precision neuron circuits DNE1 to DNEn of FIG. 5.

The double precision neuron circuit DNEK may include a first comparator CP1, a second comparator CP2, a latch circuit, a first logic gate L1, a second logic gate L2, a second transistor T2, and a first inverter I1.

The first comparator CP1 may output an intermediate spike signal MSS based on a first reference voltage V1 and the membrane voltage Vmk. For example, when the membrane voltage Vmk is lower than or equal to the first reference voltage V1, the logic value of the intermediate spike signal MSS may be ‘0’. Right when the membrane voltage Vmk of the first comparator CP1 becomes greater than the first reference voltage V1, the logic value of the intermediate spike signal MSS may be ‘1’.

For convenience of description in the present disclosure, when a signal has a high potential level, the logical value of the signal may be referred to as ‘1’, and when a signal has a low potential level, the logical value of the signal may be referred to as ‘0’.

The second comparator CP2 may output the output spike signal SOk based on a second reference voltage V2, the membrane voltage Vmk, and the intermediate spike signal MSS. The second reference voltage V2 may be greater than the first reference voltage V1. A detailed description of the operation of the second comparator CP2 will be described later.

The latch circuit may output a high-precision comparator enable signal H_EN based on the intermediate spike signal MSS and the neuron reset signal NRS. The latch circuit may output the high-precision comparator enable signal H_EN to the second logic gate L2 that enables the second comparator CP2. A description of the second logic gate L2 will be provided below.

In some embodiments, the latch circuit may be a circuit in which an S-R latch is implemented. The latch circuit may receive the intermediate spike signal MSS through an ‘S’ terminal and may receive the neuron reset signal NRS through an ‘R’ terminal. Right when the WTA device 140 receives the neuron output spike signal and outputs the neuron reset signal NRS, the logic value of the neuron reset signal NRS may be ‘1’.

For example, when the logic value of the neuron reset signal NRS is ‘O’ and the logic value of the middle spike signal MSS changes from ‘0’ to ‘1’, the logic value of the high-precision comparator enable signal H_EN may be ‘1’. In this case, when the logic value of the neuron reset signal NRS changes to ‘1’, the logic value of the high-precision comparator enable signal H_EN may be ‘0’.

The first logic gate L1 and the second logic gate L2 may enable the first comparator CP1 and the second comparator CP2, respectively, based on the comparator enable signal CP_EN and the high-precision comparator enable signal H_EN.

In some embodiments, the first logic gate L1 may be an AND gate. The first logic gate L1 may receive the comparator enable signal CP_EN and the high-precision comparator enable signal H_EN that is output from the latch circuit and then inverted through the first inverter I1.

For example, only when the logic value of the comparator enable signal CP_EN is ‘1’ and the logic value of the high-precision comparator enable signal H_EN is ‘0’, the first logic gate L1 may enable the first comparator CP1. In detail, only in this case, the first comparator CP1 may perform a comparison operation. In contrast, when the logic value of the high-precision comparator enable signal H_EN changes from ‘0’ to ‘1’, the first comparator CP1 may no longer perform the comparison operation.

In some embodiments, the second logic gate L2 may be an AND gate. The second logic gate L2 may receive the comparator enable signal CP_EN and the high-precision comparator enable signal H_EN output from the latch circuit.

For example, only when the logic values of the comparator enable signal CP_EN and the high-precision comparator enable signal H_EN output from the latch circuit are ‘1’, the second logic gate L2 may enable the second comparator CP2. In detail, only in this case, the second comparator CP2 may perform the comparison operation.

Looking again at the operation of the second comparator CP2, when the second logic gate L2 enables the second comparator CP2 based on the high-precision comparator enable signal H_EN, the second comparator CP2 may perform the comparison operation.

In some embodiments, when the membrane voltage Vmk is greater than the second reference voltage V2, the logic value of the output spike signal output from the second comparator CP2 may be ‘1’.

In detail, when it is assumed that the logic value of the comparator enable signal CP_EN is ‘1’, the operations of the first comparator CP1 and the second comparator CP2 vary depending on the membrane voltage Vmk as follows.

In some embodiments, when the membrane voltage Vmk is lower than the first reference voltage V1, the first comparator CP1 operates but the logic value of the middle spike signal MSS is ‘0’. In this case, since the logic value of the high-precision comparator enable signal H_EN is ‘0’, the second comparator CP2 may not operate.

In some embodiments, when the membrane voltage Vmk is greater than the first reference voltage V1 and lower than the second reference voltage V2, the first comparator CP1 operates and the logic value of the middle spike signal MSS is ‘1’. In this case, the logic value of the high-precision comparator enable signal H_EN is ‘1’, so the second comparator CP2 operates, but the logic value of the output spike signal SOk may be ‘0’.

In some embodiments, when the membrane voltage Vmk is greater than the second reference voltage V2, the first comparator CP1 operates and the logic value of the middle spike signal MSS is ‘1’. In this case, the logic value of the high-precision comparator enable signal H_EN is ‘1’, so the second comparator CP2 operates and the logic value of the output spike signal SOk may be ‘1’.

The WTA device 140 may receive the output spike signal SOk and may output the neuron reset signal NRS. The WTA device 140 may include a delay circuit. The logic value of the neuron reset signal NRS may change from ‘0’ to ‘1’ after a specific delay time from the point when the logic value of the output spike signal SOk changes from ‘0’ to ‘1’.

The neuron reset signal NRS may be input to the latch circuit and may be connected to a gate terminal of the second transistor T2.

The gate terminal of the second transistor T2 may be connected to the WTA device 140 to receive the neuron reset signal NRS, a drain terminal of the second transistor T2 may be connected to the first comparator CP1, and a source terminal thereof may be connected to the ground terminal GND.

For example, the second transistor T2 may be an NMOS. When the logic value of the neuron reset signal NRS is ‘1’, the second transistor T2 may be turned on to reduce the membrane voltage Vmk to the potential level of the ground terminal GND. In detail, the membrane voltage Vmk may be reset.

FIG. 7 is a diagram illustrating an address decoder of FIG. 5, according to some embodiments of the present disclosure. Referring to FIG. 7, a circuit diagram of an address decoder is illustrated.

The address decoder may receive the input address signal IA and the raw input signal IS.

The address decoder may include a delay circuit DLY. When the raw input signal IS is received, the address decoder may output the comparator enable signal CP_EN to the neuron array 130 after a specific delay time.

The number of bits of the input address signal IA received by the address decoder may be ‘n’ bits. The ‘n’ may be any natural number. For example, the input address signal IA may include a total of ‘n’ bits composing of an (n−1)-th digit bit to a 0-th digit bit IAn−1 to IA0. The bit value of each of the (n−1)-th digit bit to the 0-th digit bit IAn−1 to IA0 may be one of ‘0’ and ‘1’.

The address decoder may have a tree structure. The tree structure may include a plurality of switches. Each of the plurality of switches may be closed or opened depending on the bit value of each of the (n−1)-th digit bit to the 0-th digit bit IAn−1 to IA0 of the input address signal IA. In detail, a path within the tree structure through which the raw input signal IS is transferred may be determined depending on the bit values of each of the (n−1)-th digit bit to the 0-th digit bit IAn−1 to IA0 of the input address signal IA.

First, the raw input signal IS may be transferred to a first unit U1 of the tree structure through a first buffer B1. The first unit U1 may include a first switch s1 and a second switch s2. The first switch s1 is closed when the bit value of the (n−1)-th digit bit IAn−1 is ‘1’, and is opened in the opposite case. Since the bit value of the (n−1)-th digit bit IAn−1 inverted by the second inverter I2 is received, the second switch s2 is opened when the bit value of the (n−1)-th digit bit IAn−1 is ‘1’, and is closed in the opposite case.

For example, when the bit value of the (n−1)-th digit bit IAn−1 is ‘1’, the first switch s1 is closed and the second switch s2 is opened. Accordingly, the raw input signal IS may be transferred to a second unit U2 through a path passing through the first switch s1.

The second unit U2 may include a third switch s3 and a fourth switch s4. The third switch s3 is closed when the bit value of the (n−2)-th digit bit IAn−2 is ‘1’, and is opened in the opposite case. Since the bit value of the (n−2)-th digit bit IAn−2 inverted by a third inverter I3 is received, the fourth switch s4 is opened when the bit value of the (n−2)-th digit bit IAn−2 is ‘1’, and is closed in the opposite case.

For example, when the bit value of the (n−2)-th digit bit IAn−2 is ‘1’, the third switch s3 is closed and the fourth switch s4 is opened. Accordingly, the raw input signal IS may be transferred to a third unit U3 through a path passing through the third switch s3.

The third unit U3 may include a fifth switch s5 and a sixth switch s6. The fifth switch s5 is closed when the bit value of the (n−3)-th digit bit IAn−3 is ‘1’, and is opened in the opposite case. Since the bit value of the (n−3)-th digit bit IAn−3 inverted by a fourth inverter I4 is received, the six switch s6 is opened when the bit value of the (n−3)-th digit bit IAn−3 is ‘1’, and is closed in the opposite case.

For example, when the bit value of the (n−3)-th digit bit IAn−3 is ‘1’, the fifth switch s5 is closed and the sixth switch s6 is opened. Accordingly, the raw input signal IS may be transferred to a subsequent unit through a path passing through the fifth switch s5.

As in the above description, the path through which the raw input signal IS is transferred may be determined depending on the bit value of each of the (n−4)-th digit bit to the 0-th digit bit IAn−4 to IA0.

FIG. 8 is a diagram illustrating a circuit implementing a WTA device of FIG. 5, according to some embodiments of the present disclosure. Referring to FIG. 8, a circuit diagram of the WTA device 140 is illustrated. The WTA device 140 in FIG. 8 may correspond to the WTA device 140 in FIG. 5.

The WTA device 140 may include a PMOS transistor PM, third to eighth transistors T3 to T8, and a sixth inverter I6.

The gate terminal of the PMOS transistor PM may be connected to the ground terminal GND, the source terminal thereof may be connected to the power supply voltage VDD, and the drain terminal thereof may be connected to a first node N1.

Each of the third to eighth transistors T3 to T8 is described as being implemented as an NMOS transistor for convenience of description, but the scope of the present disclosure is not limited thereto. The drain terminal of each of the third to eighth transistors T3 to T8 may be connected to the drain terminal of the PMOS transistor PM through the first node N1. The gate terminal of each of the third to eighth transistors T3 to T8 may be connected to each of the first to n-th double precision neuron circuits DNE1 to DNEn to receive each of first to n-th output spike signals SO1 to SOk. The source terminal of each of the third to eighth transistors T3 to T8 may be connected to the ground terminal GND.

When any one of the first to n-th double precision neuron circuits DNE1 to DNEn fires, one of the third to eighth transistors T3 to T8 that receive the corresponding output spike signal as a gate signal may be turned on. In this case, the first node N1 may be connected to the ground terminal GND, and the potential level of the first node N1 may decrease to the potential level of the ground terminal GND. Accordingly, the neuron reset signal NRS may be output as ‘1’ through the sixth inverter I6.

In contrast, when all of the first to n-th double precision neuron circuits DNE1 to DNEn are not yet fired, the first node N1 may be connected to the power supply voltage VDD by the PMOS transistor PM. In this case, the neuron reset signal NRS may be output as ‘0’ through the sixth inverter I6.

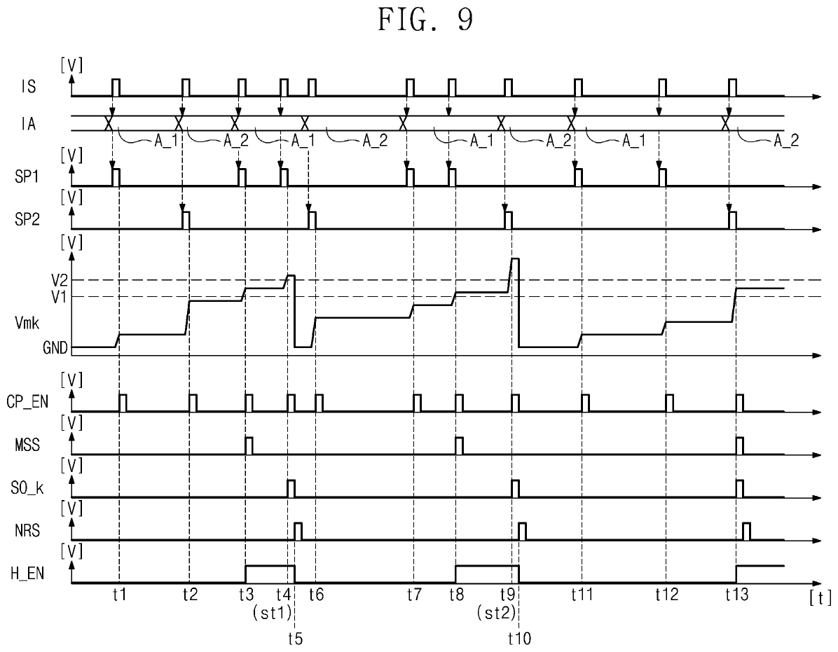

FIG. 9 is a timing diagram describing operations of an axon circuit, a synapse circuit, and a neuron circuit with respect to a raw input signal in a spiking neural network circuit of FIG. 5, according to some embodiments of the present disclosure. In FIG. 9, a horizontal axis may represent a time “t”, and a vertical axis may represent a voltage “v”. Components having the same reference numerals as the components of FIGS. 5 and 6, which are described with reference to the drawings below, may mean components that are the same as or similar to the components of FIGS. 5 and 6.

When the raw input signal IS and the input address signal IA are input to the address decoder of the axon circuit 110, the raw input signal IS may be output through the axon indicated by the input address signal IA. In FIG. 9, for convenience of description, the membrane voltage Vmk is illustrated to increase only by the first spike signal SP1 and the second input spike signal SP2, but the scope of the present disclosure is not limited thereto.

For example, when the input address signal IA points to the first axon at the point when the raw input signal IS is input, the raw input signal IS may be output as the first spike signal SP1. In contrast, when the input address signal IA points to a second axon at the point when the raw input signal IS is input, the raw input signal IS may be output as the second input spike signal SP2.

When the first input spike signal SP1 and the second input spike signal SP2 are received, the membrane voltage Vmk may increase depending on the weight determined in the synapse circuit, and the comparator enable signal CP_EN may be output.

In some embodiments, weights corresponding to each of two different axons may be the same or different. For concise and detailed description, it is assumed that the weight corresponding to the second input spike signal SP2 is greater than the weight corresponding to the first input spike signal SP1, but the scope of the present disclosure is not limited thereto.

Continuing to refer to FIG. 9, when the raw input signal IS and the input address signal IA are input at the first time to the fifth time t1 to t5 and the sixth time to the tenth time t6 to t10, the membrane voltage Vmk increases (or the membrane capacitor is charged). Among these, at the second time t2, the sixth time t6, and the ninth time t9, the weight corresponding to the second input spike signal SP2 is operated, so the increase amount (e.g., the increase amount in membrane voltage Vmk at t2, t6, and t9) in membrane voltage Vmk by the second input spike signal SP2 may be greater than the increase amount (e.g., the increase amount in membrane voltage Vmk at t1, t3, t4, t7, and t8) in membrane voltage Vmk by the first input spike signal SP1.

At the third time t3 and the eighth time t8 when the membrane voltage Vmk exceeds the first reference voltage V1, a first comparator of the double precision neuron circuit may output the middle spike signal MSS, may change the output value of the high-precision comparator enable signal H_EN to ‘1’.

At the fourth time t4 and the ninth time t9 when the membrane voltage Vmk exceeds the second reference voltage V2, a second comparator of the double precision neuron circuit may output the output spike signal SOk. In detail, a double-precision neuron circuit may fire.

After the output spike signal SOk is output and a specific delay time, the WTA device may output the neuron reset signal NRS to the double-precision neuron circuit. When the neuron reset signal NRS is output, the membrane voltage Vmk decreases to the potential level of the ground terminal GND and the high-precision comparator enable signal H_EN may be reset to ‘0’.

FIG. 10 is a diagram illustrating a first comparator and a second comparator of FIG. 6, according to some embodiments of the present disclosure. Referring to FIG. 10, a circuit diagram of the first comparator CP1 and the second comparator CP2 is illustrated.

The first comparator CP1 may include a first input transistor ITR1, twelfth to nineteenth transistors T12 to T19, and a seventh inverter I7. For convenience of description, in FIG. 10, the twelfth transistor T12 and the nineteenth transistor T19 are described as being implemented as an NMOS transistor, and the thirteenth to eighteenth transistors T13 to T18 are described as being implemented as a PMOS transistor, but the scope of the present disclosure is not limited thereto.

The first comparator CP1 may receive an enable signal EN, a positive (+) terminal input, and a negative (−) terminal input. The enable signal EN of FIG. 10 may correspond to the comparator enable signal CP_EN of FIGS. 5 and 6.

The first input transistor ITR1 may include ninth to eleventh transistors T9 to T11. Each of the ninth to eleventh transistors T9 to T11 is implemented as an NMOS transistor for convenience of description, but the scope of the present disclosure is not limited thereto. The drain terminal of the ninth transistor T9 may be connected to each of the source terminals of the tenth transistor T10 and the eleventh transistor T11 through a second node N2. The source terminal of the ninth transistor T9 may be connected to the ground terminal GND, and the gate terminal thereof may receive the enable signal EN.

The drain terminal of the tenth transistor T10 may be connected to the twelfth transistor T12 and the thirteenth transistor T13 through a third node N3. The gate terminal of the tenth transistor T10 may be connected to the positive (+) input terminal.

The drain terminal of the eleventh transistor T11 may be connected to the nineteenth transistor T19 and the eighteenth transistor T18 through a sixth node N6. The gate terminal of the eleventh transistor T11 may be connected to the negative (+) input terminal.

The source terminal of each of the thirteenth to eighteenth transistors T13 to T18 may be connected to a power supply voltage.

The drain terminal of the thirteenth transistor T13 may be connected to the third node N3 and may receive the enable signal EN through the gate terminal thereof. The drain terminal of the fourteenth transistor T14 may be connected to the drain terminal of the fifteenth transistor T15 and the drain terminal of the twelfth transistor T12 through the fourth node N4. The gate terminals of the fifteenth transistor T15 and the twelfth transistor T12 may be connected to the drain terminals of the sixteenth transistor T16 and the nineteenth transistor T19 through the fifth node N5. The gate terminals of the sixteenth transistor T16 and the nineteenth transistor T19 may be connected to the drain terminals of the fifteenth transistor T15 and the twelfth transistor T12 through the fourth node N4. The gate terminals of the seventeenth transistor T17 and the eighteenth transistor T18 may receive the enable signal EN.

The source terminal of the nineteenth transistor T19 may be connected to the sixth node N6 of the eleventh transistor T11, and the drain terminal thereof may be connected to the fifth node N5.

When the enable signal EN is ‘0’, the ninth transistor T9 of the first input transistor ITR1 may be turned off. In this case, the potential levels of the fourth node N4 and the fifth node N5 may be charged with the power supply voltage.

When the logic value of the enable signal EN is ‘1’, the potential level of one of the fourth node N4 and the fifth node N5 may decrease to the potential level of the ground terminal GND depending on the positive (+) input voltage and the negative (−) input voltage. The potential level of the fourth node N4 may be output as the intermediate spike signal MSS through the seventh inverter I7. Likewise, the second comparator CP2 may have a circuit structure similar to that of the first comparator CP1 and may operate similarly to the first comparator CP1.

For example, the second comparator CP2 may include a second input transistor ITR2, an eighth inverter I8, and twenty-third to thirtieth transistors T23 to T30. The second input transistor ITR2 may include twentieth to twenty-second transistors T20 to T22.

The twentieth to thirtieth transistors T20 to T30 of the second comparator CP2 may correspond to the ninth to nineteenth transistors T9 to T19 of the first comparator CP1, respectively, and the seventh to eleventh nodes N7 to N11 may correspond to the second to sixth nodes N2 to N6, respectively.

However, the size of the second input transistor ITR2 may be ‘N’ times the size of the first input transistor ITR1. The ‘n’ may be any natural number. For example, the width of the second input transistor ITR2 may be ‘N’ times the width of the first input transistor ITR1, and the length of the second input transistor ITR2 may be ‘N’ times the length of the first input transistor ITR1.

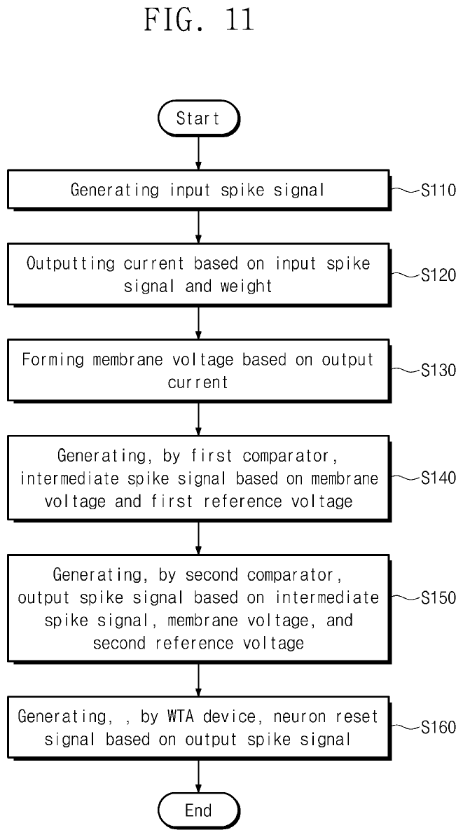

FIG. 11 is a flowchart describing a method of operating a spiking neural network circuit, according to some embodiments of the present disclosure. Referring to FIG. 11, a method of operating a spiking neural network circuit is described. The spiking neural network circuit of FIG. 11 may correspond to the spiking neural network circuit 100 of FIG. 5.

In operation S110, the spiking neural network circuit 100 may generate an input spike signal.

In some embodiments, operation S110 may include receiving an input address signal and a raw input signal, and generating an input spike signal based on the input address signal and the raw input signal.

In operation S120, the spiking neural network circuit 100 may output a current based on the input spike signal and the weight.

In operation S130, the spiking neural network circuit 100 may form a membrane voltage based on the output current.

In operation S140, the spiking neural network circuit 100 may generate an intermediate spike signal based on the membrane voltage and the first reference voltage through the first comparator.

In some embodiments, the first comparator may output the logic value of the intermediate spike signal as ‘1’ when the membrane voltage is greater than the first reference voltage.

In operation S150, the spiking neural network circuit 100 may generate an output spike signal based on the intermediate spike signal, the membrane voltage, and the second reference voltage through the second comparator.

In some embodiments, the second reference voltage may be greater than the first reference voltage.

In some embodiments, when the logic value of the intermediate spike signal is output as ‘1’, the second comparator may output the logic value of the output spike signal as ‘1’ when the membrane voltage is greater than the second reference voltage.

In operation S160, the spiking neural network circuit 100 may generate the neuron reset signal based on the output spike signal through the WTA device.

According to an embodiment of the present disclosure, a spike neural network circuit including double precision asynchronous neurons and a method of operating the same are provided.

In addition, according to an embodiment of the present disclosure, a neural network circuit including double precision asynchronous neurons that maintain precision but reduce power consumption and a method of operating the same are provided by operating the high-precision comparator with a high threshold voltage and a high power consumption only when the low-precision comparator with a low threshold voltage and a low power consumption operates first and outputs the spike signal.

The above descriptions are specific embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A spiking neural network circuit comprising:
an axon circuit configured to generate an input spike signal;
a synapse circuit configured to output a current based on the input spike signal and a weight;
a capacitor configured to form a membrane voltage based on the current; and
a neuron circuit configured to generate an output spike signal based on the membrane voltage, and
wherein the neuron circuit includes:
a first comparator configured to generate an intermediate spike signal based on the membrane voltage and a first reference voltage; and
a second comparator configured to generate the output spike signal based on the intermediate spike signal, the membrane voltage, and a second reference voltage that is different from the first reference voltage.

2. The spiking neural network circuit of claim 1, wherein the first reference voltage is lower than the second reference voltage.

3. The spiking neural network circuit of claim 1, wherein the first comparator includes a first input transistor having a first width and a first length,
the second comparator includes a second input transistor having a second width and a second length,
the second width is ‘n’ times the first width, and
the second length is ‘n’ times the first length, and
where ‘n’ is any natural number.

4. The spiking neural network circuit of claim 2, further comprising:
a latch circuit configured to generate a high-precision comparator enable signal based on the intermediate spike signal, and
wherein the second comparator operates only when a logic value of the high-precision comparator enable signal is ‘1’.

5. The spiking neural network circuit of claim 4, wherein, when the membrane voltage is greater than the first reference voltage, the first comparator outputs a logic value of the intermediate spike signal as ‘1’,
the latch circuit outputs the logic value of the high-precision comparator enable signal as ‘1’ based on the logic value of the intermediate spike signal being ‘1’, and
the second comparator compares the membrane voltage with the second reference voltage based on the logic value of the high-precision comparator enable signal being ‘1’.

6. The spiking neural network circuit of claim 1, wherein the input spike signal is a first input spike signal,
the axon circuit is a first axon circuit, and
further comprising:
a second axon circuit configured to generate a second input spike signal; and
an address encoder configured to receive an input address signal indicating one of the first axon circuit and the second axon circuit and a raw input signal, and to transfer the raw input signal to one of the first axon circuit and the second axon circuit in response to the input address signal.

7. The spiking neural network circuit of claim 6, wherein the address encoder generates a comparator enable signal based on the raw input signal, and
wherein the first comparator and the second comparator do not operate when a logic value of the comparator enable signal is ‘0’.

8. The spiking neural network circuit of claim 1, wherein the membrane voltage is a first membrane voltage,
the capacitor is a first capacitor,
the output spike signal is a first output spike signal,
the neuron circuit is a first neuron circuit, and
further comprising:
a second capacitor configured to form a second membrane voltage;
a second neuron circuit configured to generate a second output spike signal based on the second membrane voltage; and
a WTA device configured to decrease the first membrane voltage and the second membrane voltage to a potential level of a ground power supply when one of the first output spike signal and the second output spike signal is received.

9. The spiking neural network circuit of claim 8, further comprising:
an address encoder, and
wherein the address encoder is configured to:
when the WTA device receives the first output spike signal, output an output address signal indicating the first neuron circuit, and
when the WTA device circuit receives the second output spike signal, output an output address signal indicating the second neuron circuit.

10. A method of operating a spiking neural network circuit including a first comparator and a second comparator, the method comprising:
generating an input spike signal;
outputting a current based on the input spike signal and a weight;
forming a membrane voltage based on the current;
generating, by the first comparator, an intermediate spike signal based on the membrane voltage and a first reference voltage; and
generating, by the second comparator, an output spike signal based on the intermediate spike signal, the membrane voltage, and a second reference voltage that is different from the first reference voltage.

11. The method of claim 10, wherein the first reference voltage is lower than the second reference voltage.

12. The method of claim 10, wherein the generating, by the second comparator, of the output spike signal based on the intermediate spike signal, the membrane voltage, and the second reference voltage that is different from the first reference voltage includes:
generating a high-precision comparator enable signal based on the intermediate spike signal; and
when the logic value of the high-precision comparator enable signal is ‘1’, comparing, by the second comparator, the membrane voltage with the second reference voltage to generate the output spike signal.

13. The method of claim 12, wherein the generating, by the first comparator, of the intermediate spike signal based on the membrane voltage and the first reference voltage includes:
outputting, by the first comparator, a logic value of the intermediate spike signal as ‘1’ when the membrane voltage is greater than the first reference voltage, and
wherein the generating of the high-precision comparator enable signal based on the intermediate spike signal includes:
when the logic value of the intermediate spike signal is ‘1’, outputting the logic value of the high-precision comparator enable signal as ‘1’.
